(19) United States
(12) Patent Application Publication
(10) Pub. No.: US 2002/0048044 A1
(43) Pub. Date: Apr. 25, 2002

(54) Image forming device

(76) Inventor: Yasuhiko Kida, Osaka (JP)

Correspondence Address: Smith, Gambrell & Russell, LLP, Beveridge, DeGrandi,, Weilacher & Young Intellectual Property Group, 1850 M Street, N.W., Suite 800, Washington, DC, 20036, US

(21) Appl. No.: 09/964,665

(22) Filed: Sep. 28, 2001

(30) Foreign Application Priority Data
Oct. 23, 2000 (JP) 2000-322880

(51) Int. Cl. G06F 15/00

(52) U.S. Cl. 358/1.15

(57) ABSTRACT

An image forming device having an image forming section for forming an image corresponding to image data on a copy sheet and a storing section capable of storing and accumulating a plurality of jobs including image data of one or a plurality of images. This image forming device is capable of arbitrarily selecting a combination of jobs from among the jobs stored in the storing section and instructing to combine the selected plurality of jobs. When combination of the jobs is instructed, the designated jobs are read out from the storing section and given to the image forming section.

### BACKGROUND OF THE INVENTION

1. Field of the Invention

The present invention relates to image forming devices including duplicators, facsimiles, and printers, especially to digital image forming devices.

2. Description of the Related Art

As one kind of image forming devices, conventional digital duplicators include ones that are provided with sheet modes for making finally obtained copies of a good appearance. The digital duplicators of this kind are equipped with, for instance, an automatic document feeder for automatically feeding one or a plurality of documents to be scanned. Image data of documents that have been scanned after being fed by such an automatic document feeder are stored in a memory provided inside the digital duplicator.

The sheet modes includes an inter-sheet mode, which is used when image data of each document is formed on each copy sheet, for inserting an inter-sheet that is different from the copy sheet between designated pages, and a chapter mode used when a both-side-copy mode is designated for forming images such that the image data of the designated page is formed on the front side of the copy sheet.

However, when the inter-sheet mode is designated, the user needs to operate the operation panel so as to determine between which pages the inter-sheet is to be inserted, and when the chapter mode is designated, the user needs to operate the operation panel so as to determine which page is to be copied on the front side.

Some of the conventional digital duplicators are provided with an internal hard disc drive, in which a plurality of jobs (image data to be printed) can be stored. Upon a prescribed selection and instruction operation by a user, image data selected by the user are read out from the hard disc drive to be subjected to an image forming process.

However, the user can select only one job at a time in the conventional device, so that a plurality of jobs cannot simultaneously be selected for combining thereof.

### BRIEF SUMMARY OF THE INVENTION

It is an object of this invention to provide a user friendly image forming device that allows easy sheet mode setting.

Another object of this invention is to provide an image forming device capable of easily combining jobs.

The image forming device according to the present invention comprises an image forming section for forming an image corresponding to image data on a recording sheet, a storing section capable of storing and accumulating a plurality of jobs comprising image data of one or a plurality of images, a job combination instructing section for arbitrarily selecting a combination of jobs from among the jobs accumulated in the storing section and instructing to combine the selected plurality of jobs, and an image formation control means for reading out the jobs that have been designated to be combined by the job combination instructing section from the storing section and giving them to the image forming section.

According to this structure, it is possible to store a plurality of jobs being sorted out in the storing section so that image data of an arbitrarily selected job can be read out and the image thereof can be formed on recording sheets. In addition, it is possible to arbitrarily combine jobs selected from among the plurality of jobs stored in the storing section so as to form image data of the selected plurality of jobs on recording sheets, thereby obtaining desired copies.

Additionally, it is desirable for the image forming device mentioned above to further comprise an image scanning section for scanning images of documents and job storing control means for writing image data of a series of documents that are sequentially fed to the image scanning section in the storing section as one job.

According to this structure, it is possible to scan image data of a series of documents so as to store them as one job in the storing section. Accordingly, image data of one or a plurality of documents can be stored as one job.

Also, it is desirable for the image forming device according to the present invention to further comprise an automatic document feeder for feeding one or a plurality of documents to the image scanning section. In this case, a plurality of documents are set in the automatic document feeder so that image data of the set of documents can be scanned and stored automatically as one job in the storing section.

The job storing control means may also be capable of saving images of one or a plurality of documents that have been scanned after being set one by one on the image scanning section in the storing section by linking them together as one job by means of a prescribed entering operation.

It is desirable that the storing section stores data of each of the jobs, the data including image data of the job and page count data of images constituting the job.

According to this arrangement, image data together with data of the number of pages of each of the jobs are stored in the storing section so that the data of the number of pages can be stored being associated with the respective image data.

Preferably the image forming device further comprises breakpoint page processing means for calculating breakpoint page data representing locations of partitions between the jobs based on the page count data stored in the storing section when combination of a plurality of jobs is instructed by the job combination instructing section.

According to this arrangement, it is possible to find out locations of partitions between the jobs by the break point page data processing means so that each of the jobs can be distinguished from one another even when the jobs are combined.

In addition, preferably the image forming device further comprises an inter-sheet mode designating section for designating an inter-sheet mode for inserting an inter-sheet for partitioning the jobs between groups of one or a plurality of recording sheets corresponding to the respective jobs, and an inter-sheet inserting mechanism for inserting an inter-sheet between the groups of recording sheets corresponding to the respective jobs based on the breakpoint page data calculated by the breakpoint page data processing means.

According to the structure above, an inter-sheet can be automatically inserted between each of the combined jobs. It is therefore unnecessary to specify between which pages the inter-sheet is to be inserted. Accordingly, it is possible to provide a user-friendly image forming device that facilitates setting of the inter-sheet mode.

Also, preferably the image forming device further comprises a chapter mode designating section for designating a chapter mode for chaptering processing groups of one or a plurality of recording sheets corresponding to the respective jobs so as to divide them into chapters for partitioning the jobs, and a chapter partitioning mechanism for partitioning the groups of recording sheets into chapters of the respective jobs based on the breakpoint page data calculated by the breakpoint page data processing means.

According to this arrangement, when both-side-copy is designated, it is possible to automatically carry out chapter partitioning for forming the first image data of each job on the front side of the recording sheet. It is therefore unnecessary to specify which page is to be formed on the front side. Accordingly, it is possible to provide a user-friendly image forming device that facilitates setting of the chapter mode.

The above and other objects, features and advantages of the present invention will be disclosed by the following description of preferred embodiments of the invention with reference to the accompanying drawings.

### BRIEF DESCRIPTION OF THE DRAWINGS

FIG. 1 is a schematic sectional view showing the internal structure of an image forming device according to a first embodiment of this invention.

FIG. 2 is a plan view showing an appearance of the operation panel.

FIG. 3 is a block diagram showing an electrical arrangement of the image forming device.

FIG. 4 is a pattern diagram showing a data storing mode of the hard disk.

FIGS. 5(a)-5(d) illustrate a flow of display screen modes in the liquid crystal display section in connection with the operation for designating a combination mode.

FIGS. 6(e)-6(h) illustrate a flow of display screen modes in the liquid crystal display section in connection with the operation for designating a combination mode.

FIG. 7 illustrates a display area in conjunction with a storing mode of the hard disc.

FIG. 8 is a flowchart illustrating a flow of operation for designating a sheet mode.

FIGS. 9(a)-9(d) illustrate a flow of display screen modes in the liquid crystal display section in connection with the operation for designating a sheet mode.

FIG. 10 is a flowchart illustrating a flow of breakpoint page data processing control executed by the control section.

FIG. 11 illustrates an inter-sheet insertion process performed on the basis of the breakpoint page data processing.

### DETAILED DESCRIPTION OF THE INVENTION

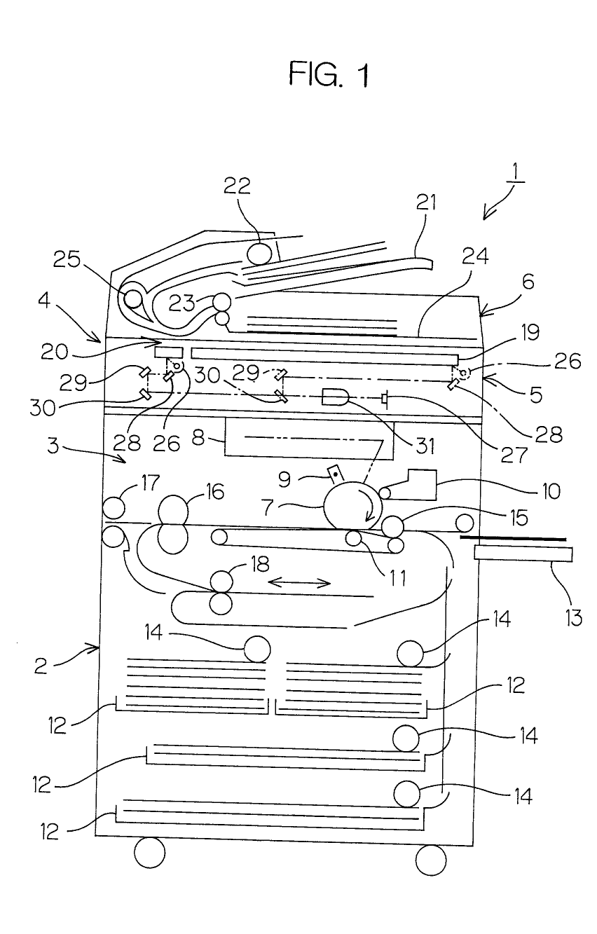

FIG. 1 is a schematic sectional view showing the internal structure of an image forming device according to a first embodiment of this invention. This image forming device 1 is a digital type duplicator having an image forming section 3 within its main body 2 shaped approximately as a rectangular solid, and an image scanning section 4 on the upper surface of the main body 2. The image scanning section 4 includes a scanner 5 and an automatic document feeder (DF) 6 provided on the upper surface of the scanner 5 in an openable/closable manner.

The image forming section 3 has: a cylindrical photoreceptor 7 that extends perpendicularly to the paper surface of FIG. 1, and is driven to rotate around its axis; and a LSU (Laser Scan Unit) 8 for selectively exposing the surface of the photoreceptor 7 to a laser light so as to write in electrostatic latent images. Around the photoreceptor 7, there are provided a main charger 9 for uniformly charging the surface of the photoreceptor 7 before exposure, a developing device 10 for developing an electrostatic latent image into a toner image, and a transferring device 11 for transferring the toner image onto a copy sheet.

The copy sheets are conveyed from a paper feed cassette 12 provided within the main body 2 or a manual paper feed tray 13 provided in a side wall of the main body 2 by means of feed rollers 14, registration rollers 15 and the like so as to be guided into the transferring device 11 at prescribed timing.

When the inter-sheet mode, which will be described later in detail, has been set, inter-sheets are to be set in the manual paper feed tray 13, for example. During the image forming operation, when a time for inter-sheet insertion comes while copy sheets stored in the feed paper cassette 12 are being conveyed to the transferring device 11, an inter-sheet is fed from the manual paper feed tray 13. The inter-sheet may be the same paper as the copy sheet, but preferably it should be a different kind of paper (such as a colored paper) for the purpose of partitioning the jobs.

The copy sheets onto which toner images have been transferred are guided to a fixing device 16 and subjected to toner image fixing treatment, and then pass through eject rollers 17 so as to be ejected outside the main body 2. The part denoted by 18 is a switchback device that works in the case of both-side-copy operation where both sides of the copy sheet are formed with images. The switchback device 18 reverses the moving direction of the copy sheet in a half completed state, that is, after one side of the copy sheet has been formed with the image, so that copy sheets are turned over and forwarded toward the photoreceptor 7 one by one at prescribed timing.

On the upper surface of the scanner 5, a transparent contact glass 19 is disposed. The user opens the automatic document feeder 6 and places a document on the contact glass 19 so as to have the document scanned.

Also, the automatic document feeder 6 can be kept in a closed state being placed on the contact glass 19 so that the document is automatically exposed to a scanning position 20 located near one end of the contact glass 19 by this automatic document feeder 6, by which the user can have the document, so to speak, run through and scanned.

The automatic document feeder 6 is provided with a paper feed roller 22 for feeding documents set in a document tray 21 to the scanning position 20 one by one from the lowest one. The forwarded documents are guided to the scanning position 20 by a plurality of conveying rollers not shown in the Figure. The documents after the scanning are ejected onto an eject tray 24 through eject rollers 23. In addition, the automatic document feeder 6 has a reverse roller 25 which works in the case of both-side-copy such that it turns over the both-side-document after one side of the document has been scanned and forwards it to the scanning position 20.

The scanner 5 is provided with a light source 26 for irradiating the document laid on the contact glass 19 from below, a CDD image sensor 27 for detecting the light reflected from the document and convert it into electrical signals, first, second and third reflection mirrors 28, 29, and 30 for guiding the light reflected from the document to the detecting surface of the CCD image sensor 27, and a lens 31 for having the optical image of the document focused on the detecting surface of the CCD image sensor 27. The light source 26 and the first reflection mirror 28 are mounted together on a first moving frame (not shown) , and the second and third reflection mirrors 29 and 30 are mounted together on a second moving frame (not shown). The moving mechanism of the first and second moving frames is arranged such that they are movable along the bottom surface of the contact glass 19 in the horizontal direction of FIG. 1, and the second moving frame moves at half the speed of the first moving frame in the same direction.

When scanning is carried out with a document being placed on the contact glass 19, the scanner 5 scans the document by moving the light source 26 from one end of the document to the other end.

On the other hand, when scanning is carried out with the automatic document feeder 6 conveying a document, the scanner 5 keeps the light source 26 stationary in the vicinity of the scanning position 20 located near one end of the contact glass 19 (near the left end in FIG. 1). In this case, scanning of the document is accomplished by transference of the document by the automatic document feeder 6.

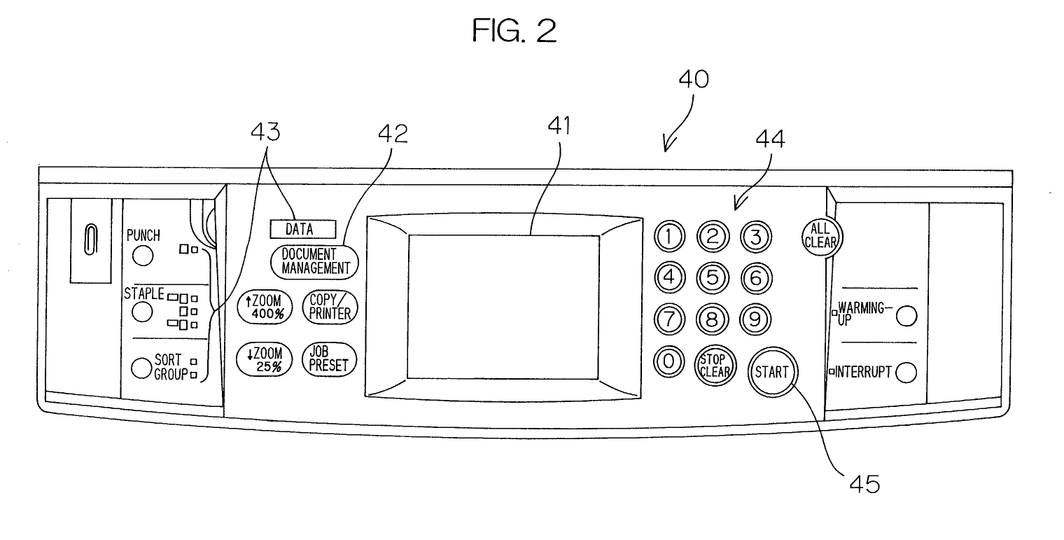

FIG. 2 is a plan view showing an appearance of the operation panel 40. Although the operation panel 40 is not shown in FIG. 1, it is disposed on the upper surface of the scanner 5 on the near side. A liquid crystal display section 41 is disposed near the center of the operation panel 40. In the area to the left of the liquid crystal display section 41 in FIG. 2, there are disposed various kinds of keys including a document management key 42 for displaying a document management screen on the liquid crystal display section 41, in which document management such as a job combining mode explained later in detail is carried out, and a LED indicator section 43 for showing operational conditions of the image forming device 1 and setting conditions of various functions. In addition, in the area to the right of the liquid crystal display section 41 in FIG. 2, there are disposed a numeric keypad 44 for entering the number of copies or the like, and a start key 45 for instructing to start the operation.

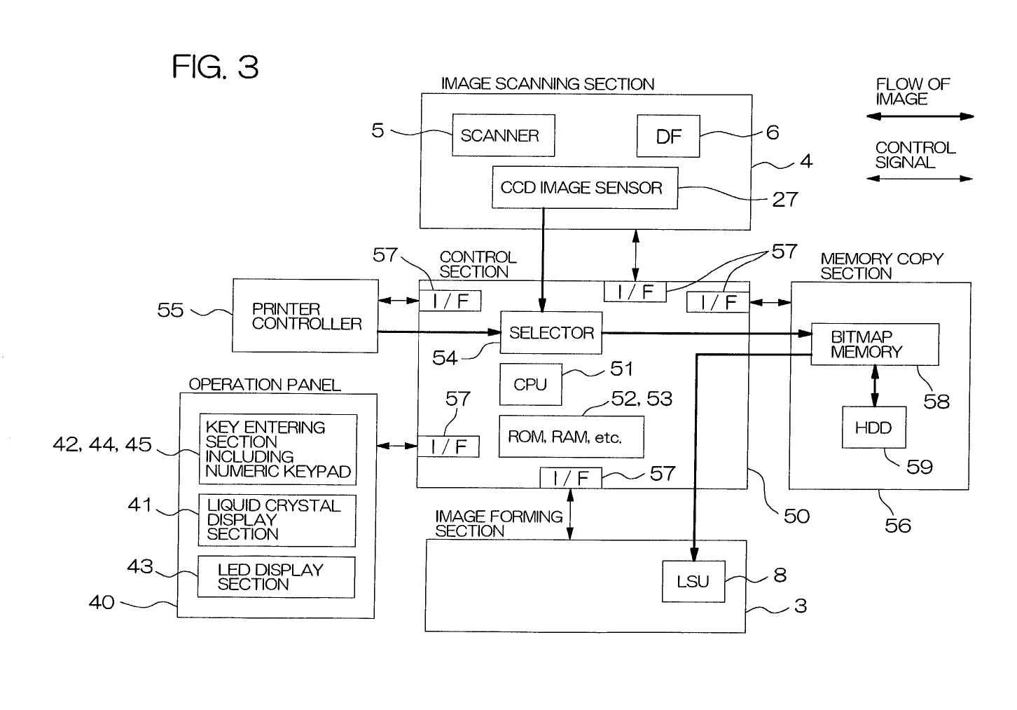

FIG. 3 is a block diagram showing an electrical arrangement of the image forming device 1. A control section 50 comprising a microcomputer and the like includes a CPU51, a RAM52, a ROM53, and a selector 54. In the ROM53, various programs have been stored previously. The operation panel 40, a printer controller 55 connected to an outer PC or the like, an image scanning section 4, a memory copy section 56 for storing image data, and an image forming section 3 are connected to the control section 50 via respective interfaces (I/F) 57 so that data can be inputted and outputted.

The operation panel 40 includes a key entry section comprising the numeric keypad 44, the document management key 42, the start key 45 and the like, the liquid crystal display section 41, and the LED indicator section 43. The key entry section provides the control section 50 with input signals in accordance with the operation by the user. The liquid crystal display section 41 displays information corresponding to the operation, or information on operational conditions or the like based on output signals from the control section 50.

The image scanning section 4 includes the scanner 5, the automatic document feeder 6, and the CCD image sensor 27. Image data that has been sent from the printer controller 55 or the CDD image sensor 27 to the control section 50 is transmitted to the memory copy section 56 through the selector 54.

The memory copy section 56 comprises a bitmap memory 58 and a hard disc drive (storing section) 59. The bitmap memory 58 is a memory for storing image data being developed for image formation, and inputted image data is compressed and stored in the hard disc drive 59. When image formation is carried out, the image data stored in the hard disc drive 59 is expanded and developed in the bitmap memory 58, and the developed image data is transferred to LSU8 in the image forming section 3 via the control section 50.

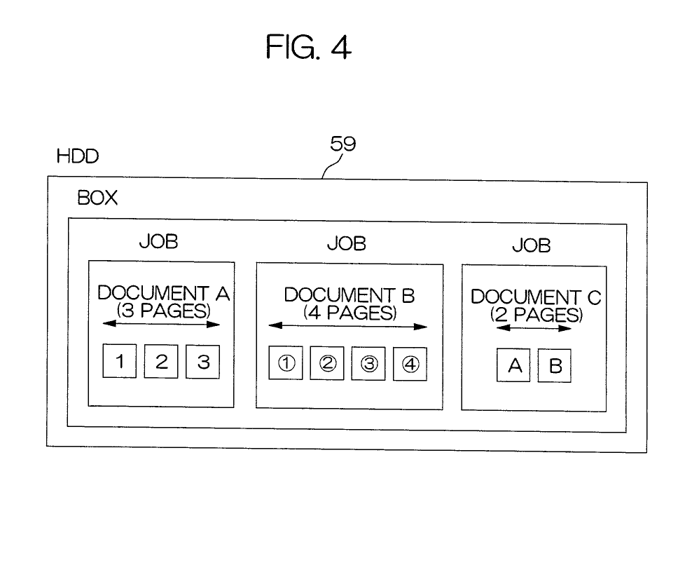

FIG. 4 is a pattern diagram showing a data storing mode of the hard disk drive. The documents A, B and C include image data of a series of documents that have been sequentially supplied to the image scanning section 4, and data of a series of documents that have been sent from an external PC through the printer controller 55. The image data of a series of documents sequentially supplied to the image scanning section 4 may be image data of a series of documents that have been supplied by the automatic document feeder 6, or may be image data of one or a plurality of documents that have been scanned being set on the image scanning section 4 one by one, in which the respective data are linked with each other so as to form image data of the series of documents by the operation of specific keys displayed on the liquid crystal display section 41. Each of the documents A, B and C is so-called a job, and a plural number of jobs are stored in a box. One box can store, for example, a hundred jobs.

The hard disc drive 59 may be capable of storing a plural number of boxes, for instance, a hundred boxes. That is, the hard disc drive 59 can store up to 10000 jobs, for example.

One of the features of this embodiment is that it has a mode for combining jobs (job-combining mode), in which jobs inside the boxes stored in the hard disc drive 59 are arbitrarily selected and combined so that the selected plurality of jobs are read out from the hard disc drive 59, thereby forming images. The job-combination may be arranged such that only jobs within one box can be combined, or jobs included in a plurality of boxes can be arbitrarily selected and combined.

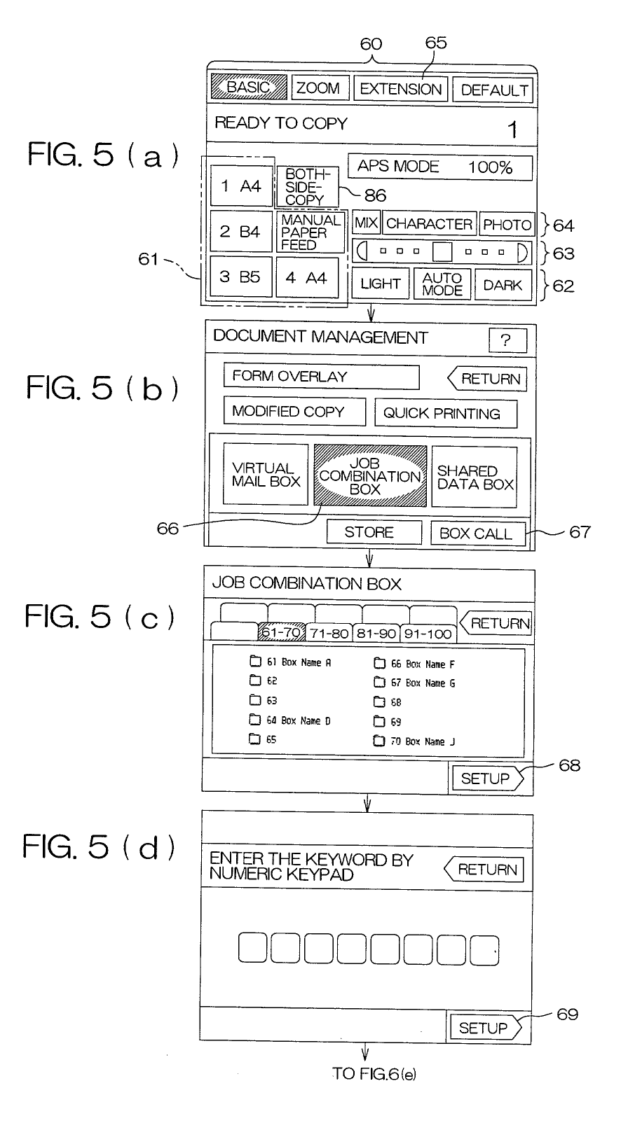

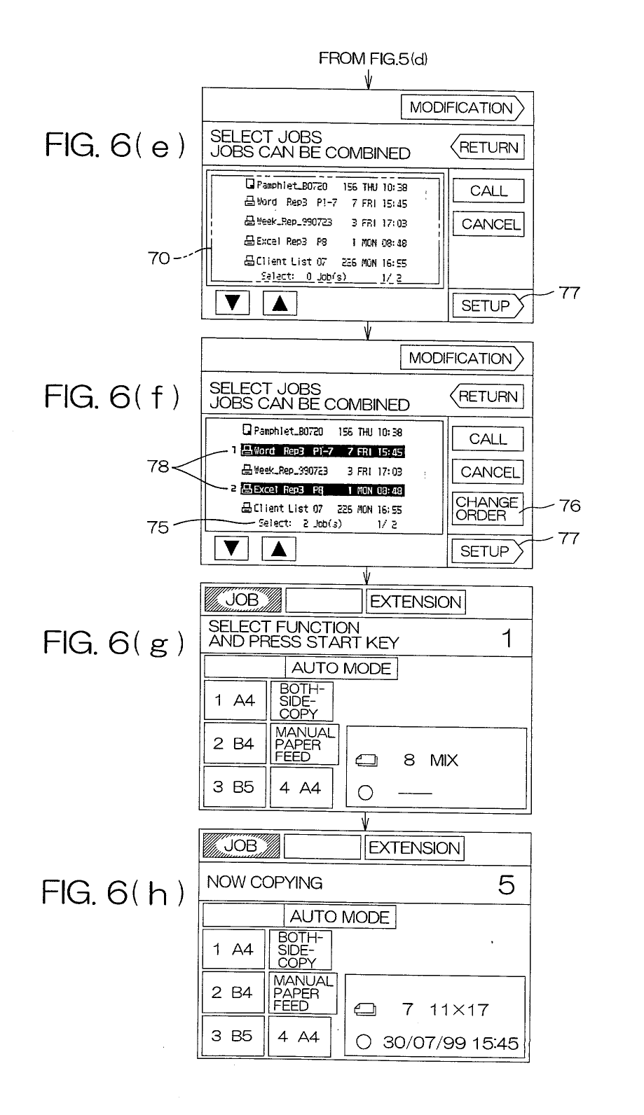

FIGS. 5(a)-5(d) and 6(e)-6(h) illustrate a flow of the display screen modes in the liquid crystal display section 41 in connection with the operation for setting a combination mode. Meanwhile, hatched keys in the keys displayed on the liquid crystal section 41 indicate that they are displayed inverted, and they have been chosen (The same applies to the cases described below).

In a standby state, the display screen of the liquid crystal display section 41 is a basic screen including a message, “Ready to copy”, as shown in FIG. 5(a). The basic screen includes function setting keys 60 for setting various functions, copy sheet designating keys 61 for designating paper feed cassette 12 or manual paper feed tray 13, both-side-key 86 for designating both-side-copy, density setting keys 62 for setting the density of the image at image forming, a density level display part 63 for displaying the level of the density set by the density setting keys 62, and image type designating keys 64 for designating the kind of the image data. The function setting keys 60 includes an extension key 65 for setting the sheet mode described later in detail.

When the user operates the document management key 42 in the operation panel 40 with the basic screen displayed, the display screen shifts to the document management screen for arbitrarily selecting one box from among a plural number of boxes including a virtual mailbox, a job-combination box and a shared data box as shown in FIG. 5(b).

When the user operates the box call key 67 after selecting one of the job-combination boxes by operating the job-combination box key 66 on the document management screen, the screen shifts to a job-combination box screen which displays names of boxes storing jobs in a list as shown in FIG. 5(c).

When the user touches any of the box names on the job-combination box screen, it is judged that the box has been designated and the box is selected. After selecting the box, when the user operates the setup key 68, the screen switches to a password entering screen as shown in FIG. 5 (d) that requires the user to enter the password. The password-entering screen includes a message, “Enter the password by numeric keypad.”

When the right password has been entered by the numeric keypad and the setup key 69 is operated, the screen shifts to a document data selection screen shown in FIG. 6 (e) for selecting jobs to be combined. This document data selection screen includes a message, “Select jobs. Jobs can be combined.”

The password entering may be omitted. In such a case, the display screen switches directly from that in FIG. 5 (c) to the screen in FIG. 6 (e).

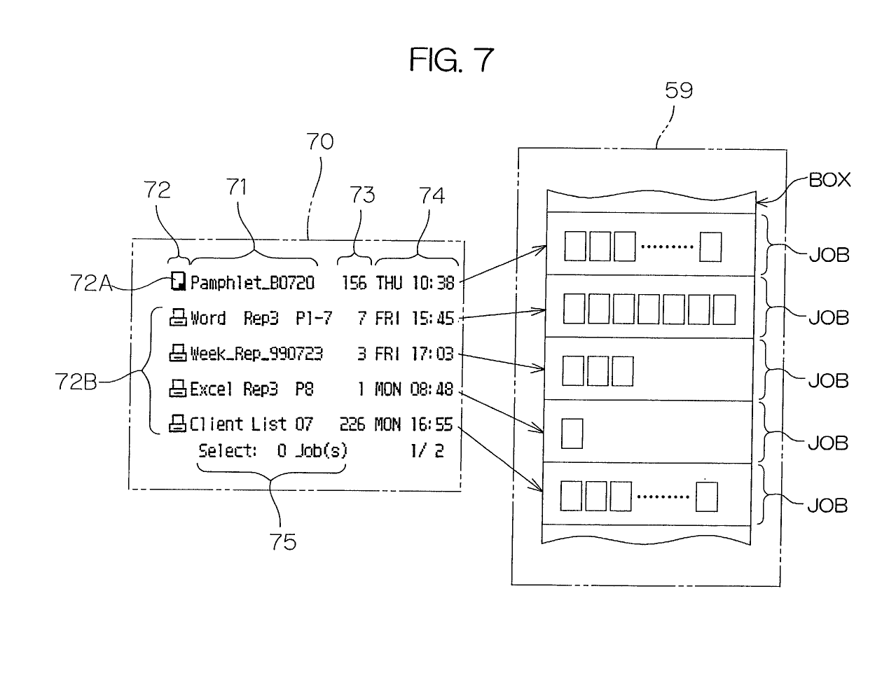

The display area 70 in the document data selection screen is shown in FIG. 7 being enlarged. FIG. 7 illustrates the display area 70 in conjunction with the storing mode in the hard disc drive 59. In the display area 70, job names 71 representing a plurality of jobs included in the selected box are shown in a list.

In the area to the left of the job names 71, icons 72 indicating the kinds of the jobs are displayed. The icon 72A indicates image data read in through the automatic document feeder 6 and the icon 72B indicates document data transmitted from an external PC through the printer controller.

In the area to the right of the job names 71, the page counts 73 of the respective jobs are displayed. That is, when the job is image data read in through the automatic document feeder 6, the number of pages of the document is displayed, and when the job is document data transmitted from an external PC, the total number of pages of the document data is displayed.

In the area to the right of the page counts 73, date and time information 74 indicating dates and times at which the respective jobs are stored is displayed. The date and time information 74 includes day of the week and time indicated in the form of 24 hours.

The jobs together with their respective data including the names 71, icons 72, page counts 73, and date and time information 74 are stocked being sorted out in the respective boxes stored in the hard disc drive 59.

In the lower part of the display area 70, a counter display part 75 for displaying the number of selected jobs is displayed.

When the user touches any job names on the document data selection screen shown in FIG. 6 (e), it is judged that the boxes have been designated and the jobs are selected, and simultaneously, a set of job information display parts indicating information on the selected jobs including the job names 71, icons 72, page counts 73 and date and time information 74 are displayed inverted as shown in FIG. 6(f).

The user can select a plural number of jobs, which are given job numbers 78 on the left sides of the icons in the order of selection. The order of these job numbers 78 corresponds to the order of combination at the time of job combination. It is possible for the user to change the order of the job numbers 78 by operating an order change key 76 after selecting a plurality of jobs.

When the user operates the setup key 77 after selecting the boxes, the display screen shifts to the screen shown in FIG. 6(g) including a message, “Select functions and press start button”, and setting of the job-combination mode is completed.

Following this step, when the user operates the start key 45 on the operation panel 40, the display screen switches to the screen shown in FIG. 6 (h) including a message, “Now copying”, and at the same time, operation of the image forming device 1 is started. Upon start of the operation, the selected jobs are read out from the hard disc drive 59 in the order of the job numbers 78, and the respective image data are combined together so as to be formed into images on the copy sheets.

Another feature of this embodiment is that this embodiment allows sheet modes to be automatically executed without requiring page number input, the sheet modes including an inter-sheet mode for inserting an inter-sheet, which is different from the copy sheet, between the jobs combined by the job-combination mode, and a chapter mode for forming images such that the first image data of each job is formed into an image on the front side of the copy sheet when the both-side-copy is designated. Accordingly, it is possible to provide a user-friendly image forming device allowing for easy sheet mode setting.

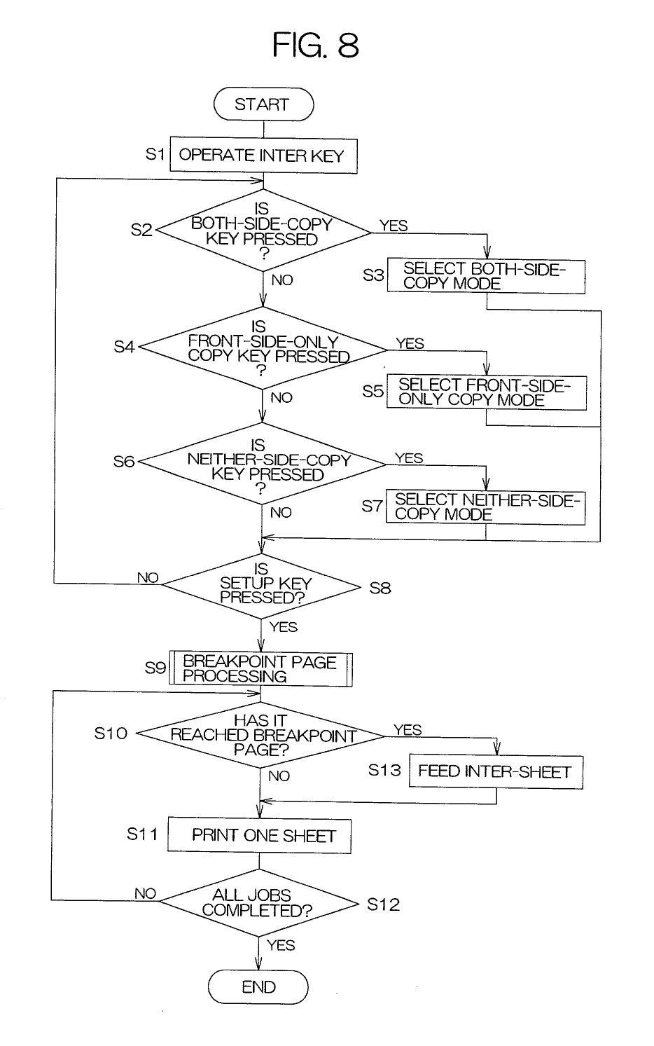

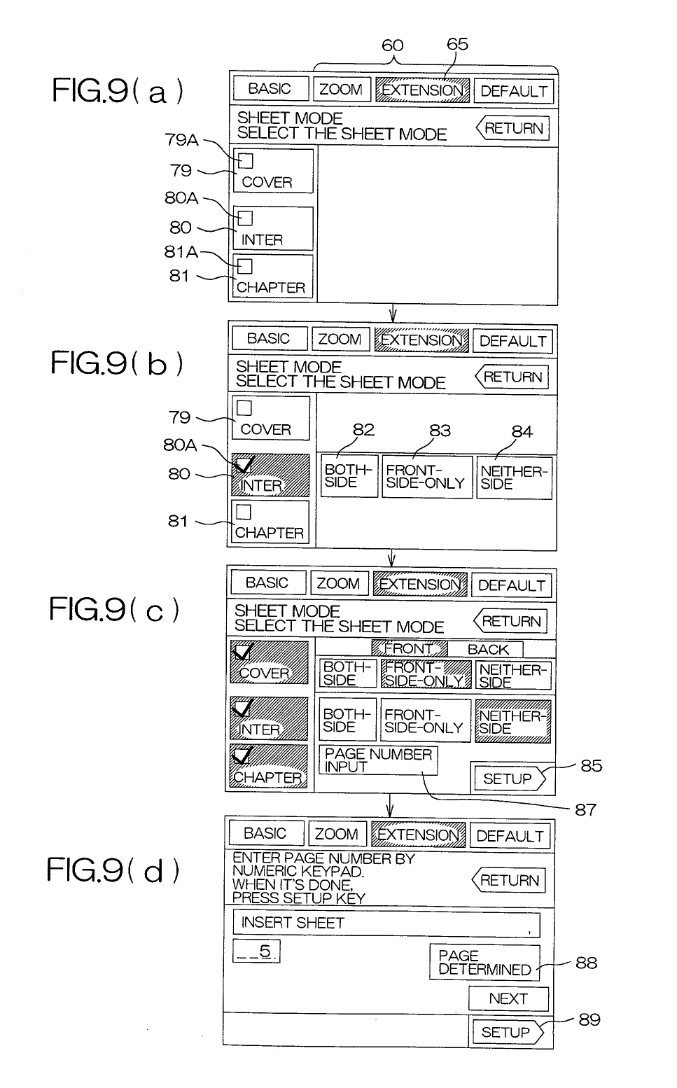

FIG. 8 is a flowchart illustrating a flow of the operation for setting the sheet mode, and FIGS. 9 (a)-9(d) illustrate a flow of the display screen of the liquid crystal display section 41 in connection with the operation for setting the sheet mode.

When the user operates the extension key 65 on the basic screen shown in FIG. 5 (a), the display screen shifts to the sheet mode setting screen shown in FIG. 9 (a) including a message, “Designate a sheet mode.” The sheet mode setting screen includes a cover key 79, an inter key 80, and a chapter key 81 for designating the cover mode, inter-sheet mode, and chapter mode, respectively.

The cover mode is a mode for attaching a cover sheet that is different from the copy sheet such as a board to the top or the end of a complete set of copies. The inter-sheet mode is a mode for inserting an inter-sheet that is different from the copy sheet between the jobs combined by the job-combination mode. The chapter mode is a mode for forming images such that the first image data of each job is formed into an image on the front side of the copy sheet when the both-side-copy is designated.

The keys 79, 80 and 81 include check boxes 79A, 80A and 81A, respectively. When any of these modes is selected, one of the check boxes 79A, 80A and 81A in the keys 79, 80 and 81 corresponding to the selected mode is check-marked. The number of sheet modes that can be set at a time is not limited to one but may be plural.

When the inter key 80 is operated on the sheet mode setting screen (Step S1), the display screen switches to the condition mode setting screen shown in FIG. 9 (b) for selecting an image forming condition mode for the inter-sheet, and the check box 80A in the inter key 80 is checked. The condition mode setting screen includes a both-side-copy key 82 for designating the mode for forming the image on both sides of the inter-sheet, a front-side-only copy key 83 for designating the mode for forming the image only on the front side of the inter-sheet, and a neither-side-copy key 84 for designating the mode for not forming the image on either the front or back of the inter-sheet.

When any of the both-side-copy key 82, front-side-only copy key 83 and neither-side-copy key 84 is operated on the condition mode setting screen (YES in any of the Steps S2, S4, and S6), the selected key is displayed inverted as well as the corresponding condition mode is selected (Steps S3, S5, S7).

As shown in FIG. 9 (c), for instance, when the neither-side-copy key 84 is operated (YES in Step S6) and the setup key 85 is operated thereafter (YES in Step S8), setting of the sheet-mode is completed. According to the setting in this embodiment, an inter-sheet whose neither side is formed with the image is automatically inserted between each of the jobs.

When the inter-key 80 is operated again, the inter sheet mode setting is cleared, and simultaneously, the check mark in the check box 80A included in the inter-key 80 is removed.

When the inter-sheet mode is designated (YES in Step S8) and the start key 45 on the operation panel 40 is operated, breakpoint page data processing for calculating breakpoint page data representing locations of partitions between the individual jobs is executed based on the page count data stored in the hard disc drive 59 (Step S9).

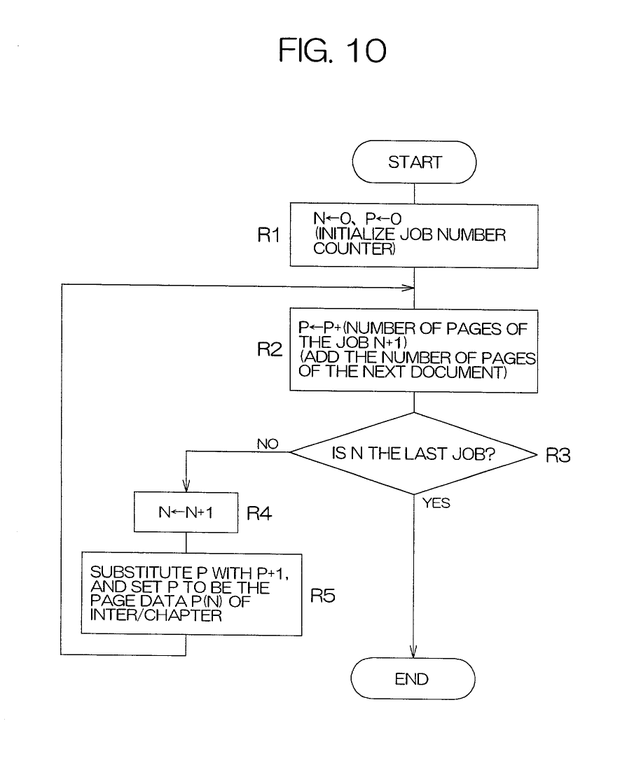

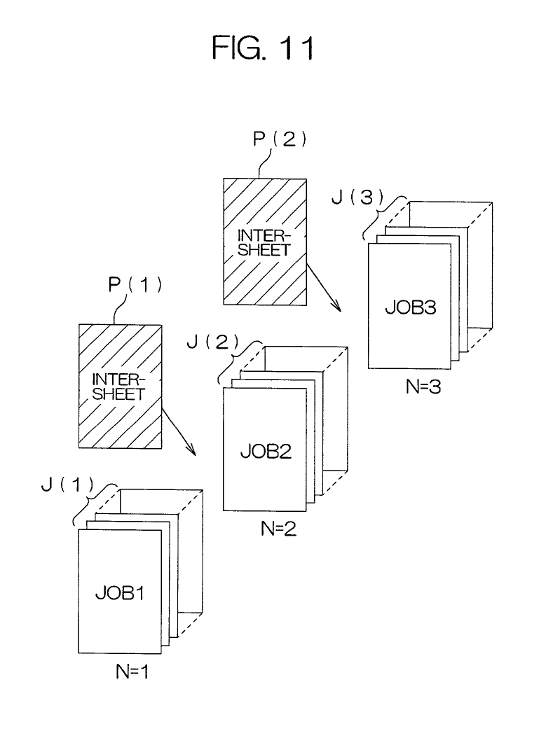

FIG. 10 is a flowchart illustrating a flow of controlling operation of the breakpoint page data processing performed by the control section 50, and FIG. 11 illustrates the inter-sheet inserting process on the basis of the breakpoint page data processing. As an example, the breakpoint page data processing is hereinafter discussed, in the case where three jobs including JOB1, JOB2, and JOB3 having page counts J(1), J(2), and J(3), respectively, are combined in this order. The numbers in the parentheses of the page counts J(1), J(2) and J(3) indicate the job numbers.

The control section 50 has a job number counter N for counting the job numbers 78 and a page counter P for counting the numbers of pages. When the breakpoint page data processing is started, first, the counters N and P are initialized to 0 (Step R1).

Then, the page count of the job of the job number (N+1) is added to the counter P so that the resultant value is the value of the counter P (Step R2) . Since the initial values of the counters N and P are 0 in Step R1, it is known from the mathematical formula below that the value of the counter P is J(1), that is, the page count of the job JOB1 of the job number N=1.

P=0+J (0+1)=J (1)

Since the value of the counter N has not reached the job number N=3 of the final job (NO in Step R3), the counter N is to receive an increment in Step R4, and in Step R5, the value of the counter P becomes J(1)+1 according to the following formula.

P=P+1=J (1)+1

This value of the counter P is set as the first breakpoint page P(1). That is, the page following the last page of the job JOB1 of the job number N=1 is set as the first breakpoint page.

Then the processing returns to Step R2, where the value of the counter P becomes J(1)+J(2)+1 according to the formula below, that is, the page count of the JOB2 of the job number N=2 is added.

P=P+J (1+1)=(J(1)+1)+J (2)

=J(1)+J(2)+1

Because the value of the counter N has not reached the job number N=3 of the last job (NO in Step R3), the counter N is to receive an increment in Step R4, and then in Step R5, the value of the counter P becomes J(1)+J(2)+2 according to the following formula.

P=P+1=J(1)+J(2)+2

This value of the counter P is set as the second breakpoint page P(2). That is, the page following the last page of the job JOB2 of the job number N=2 is set as the second breakpoint page.

Then, the processing returns again to Step R2, where the value of the counter P becomes J (1)+J (2)+J (3)+2 according to the formula below, that is, the page count of the job JOB3 of the job number N=3 is added.

P=P+J(2+1)=(J(1)+J(2)+2)+J(3)

=J(1)+J(2)+J(3)+2

Here, the value of the counter N has reached the job number N=3 of the last job (YES in Step R3), the breakpoint page data processing is therefore completed.

Upon completion of the breakpoint page data processing, image formation is initiated. First, whether the page count has reached the first breakpoint page P (1) or not is determined (Step S10 in FIG. 8).Since it has not reached the first breakpoint page (NO in Step 10), the image of the job JOB1 of the job number N=1 is formed on one copy sheet supplied from the paper feed cassette 12, as well as the page count gets an increment. Since not all jobs have been completed (NO in Step S12), the processing returns to Step S10 and whether the page count has reached the breakpoint page P(1) or not is judged again. After repetition of Steps S10-S12, when all the images of the job JOB1 of the job number N=1 have been formed and it is determined that the page count has reached the breakpoint page P(1) in Step S10, a first inter-sheet is supplied from the manual feed tray 13 (Step S13). At this point, the page count also gets an increment.

Since a case where neither side of the inter-sheet is formed with the image is supposed here, no image is formed on the inter-sheet in Step S11.

Because not all the jobs have been completed (NO in Step S12) , the processing returns again to Step S10, where whether the page count has reached the second breakpoint page P(2) or not is determined. Then, after repetition of Steps S10-S12 again, when all the images of the job JOB2 of the job number N=2 have been formed and it is determined that the page count has reached the second breakpoint page P(2) in Step S10, a second inter-sheet is supplied (Step S13).

Because not all the jobs have been completed (NO in Step 12), the processing returns to Step S10, where whether the page count has reached the third breakpoint page P(3) or not is determined. Since P(3) does not exist in the above case, the Steps S10-S12 are repeated again, and when all the images of the job JOB3 of the job number N=3 have been formed, it is determined that all the jobs have been completed in Step S12 (YES in Step S12), and the image formation is finished.

The chapter mode can be set in cases where the both-side-key 86 is operated on the basic screen shown in FIG. 5 (a), and is selected when the chapter key 81 is operated on the sheet mode setting screen shown in FIG. 9 (a). When the chapter mode is selected, similarly to the case of the inter-sheet mode setting, the check box 81A included in the chapter key 81 is check-marked. The setting of the chapter mode is then completed by operation of the setup key 85. According to a controlling flow similar to that in the case of the inter-sheet mode, images are formed such that the first image data of each job is formed into an image on the front side of the copy sheet when the both-side-copy is designated.

However, the chapter mode is not limited to the kind that forms images such that the first image data of each job is formed into an image on the front side of the copy sheet, but may be others such as a kind that provides each job with a different chapter number.

In this embodiment, it is possible to automatically insert an inter-sheet between each group of combined jobs as described above. In addition, it is also possible to insert an inter-sheet between any arbitral two pages.

When the image forming condition mode is selected as shown in FIG. 9 (c), a page input key 87 is displayed on the screen. When the page input key 87 is operated, the display screen switches to the page input screen shown in FIG. 9 (d). The page input screen includes a message: “Enter a page number by numeric keypad. When it's done, press setup button.” When the user enters an arbitral page number and operates the page determination key 88, setting is made such that an inter-sheet is inserted into the designated page. Then, the setup key 89 is pressed to complete the sheet mode setting.

The present invention is not limited to the embodiments discussed above, but may be modified in many ways within the scope of the appended claims. For example, the image forming device according to this invention is not necessarily a digital duplicator, but may be applied to a printer.

In addition, the inter-sheet mode and the chapter mode can be selected at the same time.

The job combination may be performed when an integration mode such as “2-in-1” mode or “4-in-1” mode is designated. In this case, images of different jobs to be combined may be formed on different copy sheets. Alternatively, one copy sheet may carry images that belong to two or more different jobs. Provision is made, for example, that a job A having 11 pages is combined with another job B with the 2-in-1 mode designated. In this case, the sixth copy sheet may carry the eleventh page image of the job A and the first page image of the job B. Thus, the jobs A and B are continuous on the resultant copy sheets, providing a good appearance.

There is an image forming device such as a digital duplicator that is capable of connecting to another image forming device for mutual image data transfer via a communication line such as a cable. In such a case, job combination may be made on the jobs that are stored in the respective data storing means provided in the different image forming devices, whereby a user need not transfer the image data of the job to be combined from one device to another in advance.

Preferred embodiments of the present invention have been described so far in detail. However, these are examples intended only to illustrate the technical features of this invention, and the present invention should not be construed as limited to these examples. The spirit and scope of the present invention are to be determined solely by the appended claims.

This application corresponds to an application No. 2000-322880 filed in Japanese Patent Office on Oct. 23, 2000, the entire content of which is incorporated hereinto by reference.

1. An image forming device comprising:
an image forming section for forming an image corresponding to image data on a recording sheet;
a storing section capable of storing and accumulating a plurality of jobs including image data of one or a plurality of images;
a job combination instructing section for arbitrarily selecting a combination of jobs from among the jobs accumulated in the storing section and instructing to combine the selected plurality of jobs; and
an image formation control means for reading out the jobs that have been designated to be combined by the job combination instructing section from the storing section and giving them to the image forming section.

2. The image forming device according to claim 1, further comprising:
an image scanning section for scanning an image of a document; and
job storage control means for writing image data of a series of documents that have been sequentially fed to the image scanning section in the storing section as one job.

3. The image forming device according to claim 2, further comprising:
an automatic document feeder for automatically feeding one or a plurality of document sheets to the image scanning section, wherein the job storage control means write image data of a series of document sheets that have been set in the automatic document feeder and automatically fed to the image scanning section in the storing section as one job.

4. The image forming device according to claim 1, wherein the storing section stores data of each of the jobs, the data including image data of the job and page count data of images constituting the job.

5. The image forming device according to claim 4, further comprising
breakpoint page processing means for calculating breakpoint page data representing locations of partitions between the jobs based on the page count data stored in the storing section when combination of a plurality of jobs is instructed by the job combination instructing section.

6. The image forming device according to claim 5, further comprising:
an inter-sheet mode designating section for designating an inter-sheet mode for inserting an inter-sheet for partitioning the jobs between groups of one or a plurality of recording sheets corresponding to the respective jobs; and
an inter-sheet inserting mechanism for inserting an inter-sheet between the groups of recording sheets corresponding to the respective jobs based on the breakpoint page data calculated by the breakpoint page data processing means.

7. The image forming device according to claim 5, further comprising:
a chapter mode designating section for designating a chapter mode for chaptering processing groups of one or a plurality of recording sheets corresponding to the respective jobs so as to divide the jobs into chapters for partitioning the jobs, and a chapter partitioning mechanism for partitioning the groups of recording sheets into chapters of the respective jobs based on the breakpoint page data calculated by the breakpoint page data processing means.
